(19) United States
(12) Patent Application Publication
(10) Pub. No.: US 2006/0164697 A1
(43) Pub. Date: Jul. 27, 2006

(54) Irregularly spacing linear portions of media sheet for optical scanning thereof

(76) Inventor: David R. Larson, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/043,514

(22) Filed: Jan. 26, 2005

(51) Int. Cl. H04N 1/46

(52) U.S. Cl. 358/509

(57) ABSTRACT

A method and apparatus for optically scanning a media sheet effectively advances the media sheet relative to a light source. The media sheet is logically divisible into linear portions. Each linear portion has a number of positions. The linear portions are irregularly spaced relative to one another. As the light source becomes incident to each position of each linear portion of the media sheet, the light reflected by the position is optically detected to optically scan the position.

### BACKGROUND

Optical scanning of media sheets is a way to acquire digital representations of paper documents. That is, optical scanning is a way to digitize paper documents, such as black-and-white letters, color photographs, and so on. Optical scanners work by emitting light against a portion of the media sheet, and detecting how the light is reflected by that portion of the media sheet. Parts of the media sheet that have something printed on them, either in black and white or in color, reflect light differently than parts of the media sheet that do not have anything printed on them. The process is repeated for all portions of the media sheet, until the entire sheet has been optically scanned.

Most optical scanners scan media sheets on a line-by-line basis. Thus, a first line of a media sheet is scanned, then the next line, and so on, until the entire media sheet has been completely optically scanned. Either the optical scanning mechanism can be moved over a whole media sheet to scan the sheet on a line-by-line basis, or the media sheet can be advanced past a stationary optical scanning mechanism to achieve scanning of the entire media sheet. Most optical scanning mechanisms are able to scan an entire line of a media sheet at one time, whereas other optical scanning mechanisms move from left to right over a given line of the media sheet to scan all the positions of that line.

The line-by-line nature of optical scanning is susceptible to visual artifacts or distortions known as Moiré patterns. Moiré patterns are rippled, water-like distortions that typically result when scanning half-toned, or dithered, images on a line-by-line basis. Such half-toned images are a common way by which laser and other printers achieve gray-scale images. To eliminate Moiré patterns, some optical scanners optically blur the images that they scan, which is disadvantageous because some detail in the scanned image may be lost. Other optical scanners employ digital image processing to eliminate Moiré patterns, but this can be a time-consuming process, and can require expensive additional hardware to be added to the scanner.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of a media sheet that has been logically divided into a number of irregularly spaced linear portions for optical scanning, according to an embodiment of the invention.

FIG. 2 is a diagram of some of the irregularly spaced linear portions of the media sheet of FIG. 1 in detail, according to an embodiment of the invention.

FIG. 3 is a diagram of a side view of how optical scanning can occur where the media sheet moves past an optical scanning mechanism that is stationary in the direction of movement of the media sheet, according to an embodiment of the invention.

FIG. 4 is a diagram of a side view of how optical scanning can occur where the optical scanning mechanism moves past a stationary media sheet, according to an embodiment of the invention.

FIG. 5 is a diagram of a front view of how optical scanning can occur such that all the positions of a linear portion of a media sheet are optically scanned at the same time, according to an embodiment of the invention.

FIG. 6 is a diagram of a front view of how optical scanning can occur such that the positions of a linear portion of a media sheet are optically scanned on a position-by-position basis, where the optical scanning mechanism moves over all the positions, according to an embodiment of the invention.

FIG. 7 is a flowchart of a method for optically scanning a media sheet such that the linear portions of the media sheet that are optically scanned are irregularly spaced, according to an embodiment of the invention.

FIG. 8 is a flowchart of a method for optically scanning a media sheet such that the linear portions of the media sheet that are optically scanned are irregularly spaced, according to another embodiment of the invention.

FIG. 9 is a block diagram of a rudimentary optical scanning device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

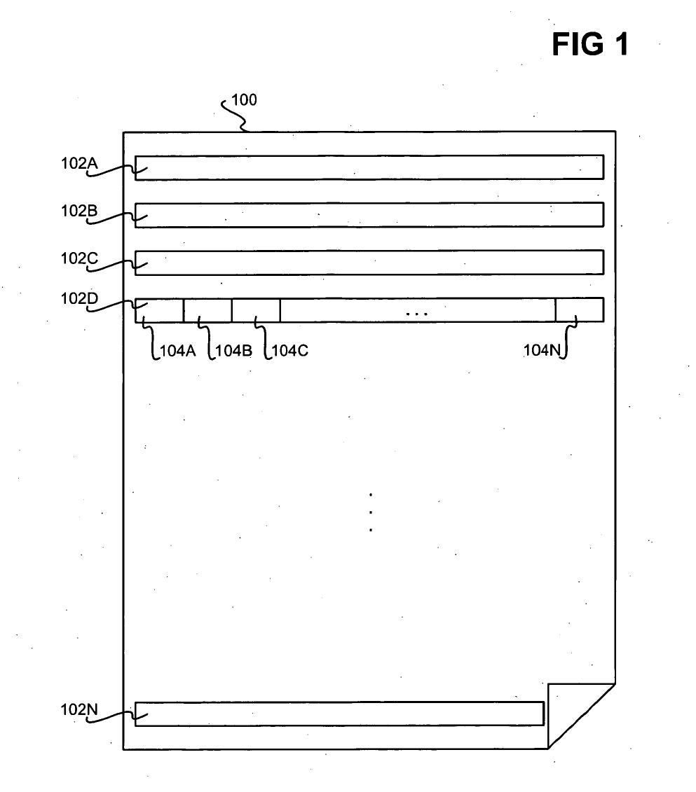

FIG. 1 shows how a media sheet 100 is logically divided into a number of linear portions for optical scanning purposes, according to an embodiment of the invention. The media sheet 100 is specifically logically divided into linear portions 102A, 102B, 102C, 102D, . . . , 102N, collectively referred to as the linear portions 102. The media sheet 100 has an image printed thereon, such as black-and-white text or graphics, color text or graphics, and so on, that is to be digitized by optically scanning the linear portions 102 of the media sheet 100. This image is not depicted in FIG. 1 for illustrative clarity and convenience.

Each of the linear portions 102 is a part of the media sheet 100 that is specifically optically scanned. The linear portions 102 are typically much smaller in size than depicted in FIG. 1, and their size is exaggerated in FIG. 1 for illustrative clarity. Thus, the linear portions 102 are optically scanned on a linear portion-by-linear portion basis. First, the linear portion 102A is optically scanned, then the linear portion 102B is optically scanned, and so on, until the media sheet 100 is completely optically scanned when the linear portion 102N is optically scanned. The media sheet 100 is considered to be logically divided into the linear portions 102 in that the linear portions 102 are not actual physical lines on the media sheet 100, but is how the media sheet 100 is divided logically so that optical scanning of the entire media sheet 100 can be accomplished.

The linear portions 102 themselves may be considered as each having a number of positions. For example, the linear portion 102D is depicted as having a number of positions 104A, 104B, 104C, . . . , 104N, collectively referred to as the positions 104 of the linear portion 102D of the media sheet 100. Thus, whereas the linear portions 102 divide the media sheet 100 from a top of the sheet 100 to a bottom of the sheet 100, the positions divide each of the portions 102 from a left of the media sheet 100 to the right of the sheet 100. For example, the positions 104 of the linear portion 102D extend from the left of the media sheet 100 to the right of the sheet 100.

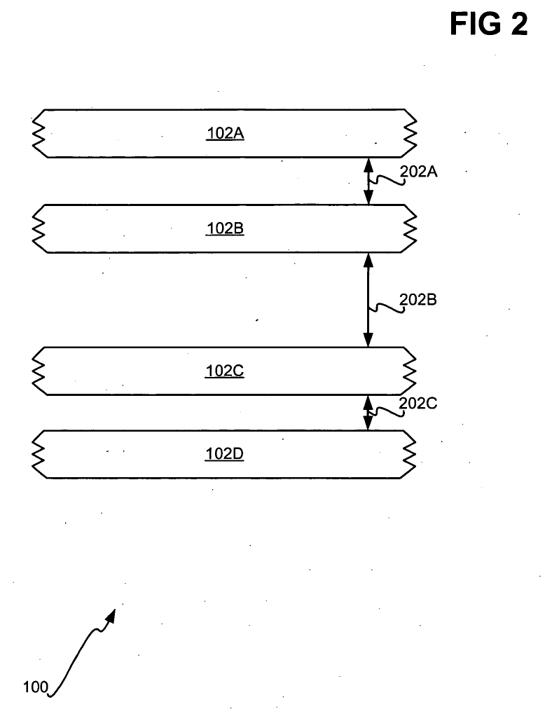

FIG. 2 shows how the linear portions 102 of the media sheet 100 are irregularly spaced, according to an embodiment of the invention. Just the linear portions 102A, 102B, 102C, and 102D are depicted in FIG. 2 for illustrative clarity. The linear portions 102 are irregularly spaced from one another in FIG. 2. That is, the spacing 202A between the linear portions 102A and 102B is not necessarily equal to the spacing 202B between the linear portions 102B and 102C nor to the spacing 202C between the linear portions 102C and 102D. The spacings 202A, 202B, and 202C are collectively referred to as the spacings 202, and are thus irregular spacings in that they are not necessarily equal to one another. For example, in FIG. 2, the spacing 202B is greater than the spacing 202C, which is greater than the spacing 202A.

Irregularly spacing the linear portions 102 reduces or eliminates Moiré patterns when scanning the image on the media sheet 100. Moiré patterns can result because the linear portions of a media sheet are regularly spaced, giving rise to these visual artifacts or distortions. By spacing the linear portions 102 so that the spacings 202 therebetween are not necessarily equal to one another, and frequently are not equal to one another, the ability of the human eye to discern Moiré patterns is greatly reduced. Such reduction or elimination of Moiré patterns especially results where the image on the media sheet 100 is a half-tone image.

The manner by which the spacings 202 are determined as irregular spacings can vary in different embodiments of the invention. In one embodiment, there is a target value for the spacings 202. A random number that has a lower, negative limit and an upper, positive limit is generated for each of the spacings 202, and is added to the target value to determine each of the spacings 202. Thus, the net result is that the spacings 202 are substantially equal to one another, but vary from one another by the random value added to the target value.

In another embodiment, a look-up table may be utilized to determine each of the spacings 202, depending on which of the linear portions 102 the spacing in question precedes or succeeds. In a different embodiment, an equation or algorithm may be employed to determine each of the spacings 202. In one particular embodiment, the average of all the spacings 202 is equal to a predetermined constant target value, where each of the spacings 202 varies from that value by a small amount.

The irregular spacings 202 can be achieved in at least two different ways. First, after each of the linear portions 102 of the media sheet 100 is optically scanned, either the media sheet 100 or an optical scanning mechanism is moved by a variable amount to achieve a given one of the irregular spacings 202. For example, after the linear portion 102A has been optically scanned, the media sheet 100 or the optical scanning mechanism is moved by an amount so that the linear portion 102B is located by the spacing 202A away from the linear portion 102A. After the linear portion 102B is optically scanned, the media sheet 100 or the optical scanning mechanism is moved by a different amount so that the linear portion 102C is located by the spacing 202B away from the linear portion 102B, where the spacing 202B is different than the spacing 202A.

Second, an optical scanning mechanism or the media sheet 100 may be moved or advanced at a constant velocity until the media sheet 100 has been completely moved past the optical scanning mechanism. Therefore, the timings at which the optical scanning mechanism are turned on and off are varied to achieve the irregular spacings 202. For example, after the linear portion 102A is optically scanned, a length of time is waited while the media sheet or the optical scanning mechanism continues to move. Once this length of time has elapsed, the optical scanning mechanism is turned on and off to scan the linear portion 102B, such that the linear portion 102B is spaced away from the linear portion 102A by the irregular spacing 202A due to the length of time that has been waited. Turning on the optical scanning mechanism in this context means turning on a light source within the mechanism to emit the light to be reflected by the linear portion in question, and/or turning on light detectors within the mechanism to detect the light reflected by the linear portion in question. Turning off the optical scanning mechanism in this context thus means turning off the light source and/or the light detectors that were previously turned on.

After the linear portion 102B is optically scanned, a different length of time is waited while the media sheet or the optical scanning mechanism continues to move. Once this length of time has elapsed, the optical scanning mechanism is turned on and off to scan the linear portion 102C. The linear portion 102C is spaced away from the linear portion 102A by the irregular spacing 202B due to the length of time that has been waited for. The spacing 202B is different than the spacing 202A because the length of time waited in between the linear portions 102A and 102B, while the optical scanning mechanism or the media sheet 100 continues to move at constant velocity, is different than the length of time waited in between the linear portions 102B and 102C. The length of time waited to achieve the spacing 202B is greater than the length of time waited to achieve the spacing 202A, resulting in the spacing 202B being greater than the spacing 202A.

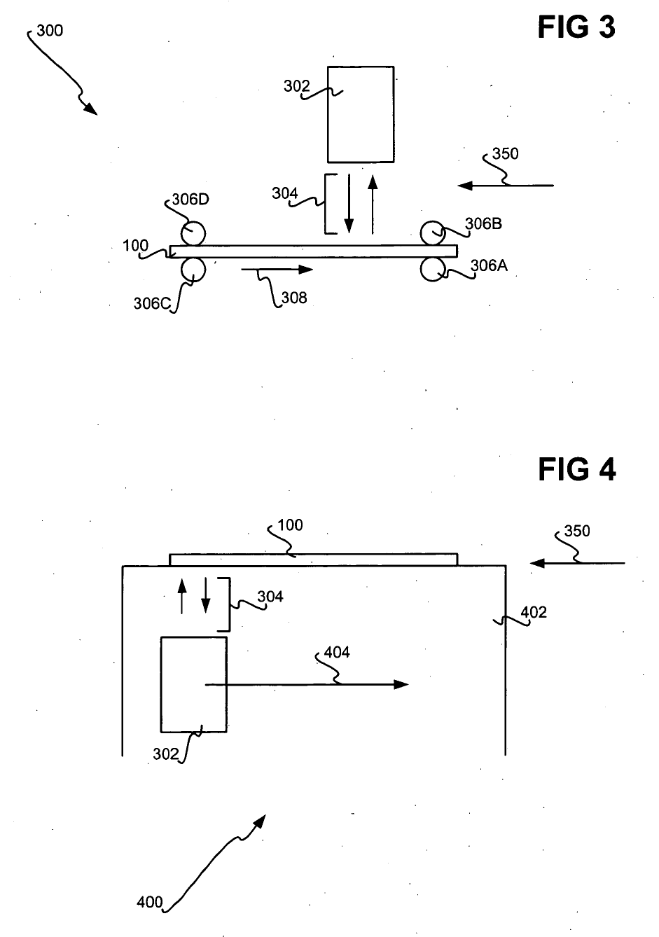

FIGS. 3 and 4 show side profiles 300 and 400, respectively, of how optical scanning can be accomplished by either moving the media sheet 100 past an optical scanning mechanism 302, or vice-versa, according to different embodiments of the invention. In the side profile 300 of FIG. 3, the media sheet 100 moves past the optical scanning mechanism 302, which is stationary in the direction of movement of the media sheet as indicated by the arrow 308. The top of the media sheet 100 corresponds to the right part of FIG. 3, whereas the bottom of the media sheet 100 corresponds to the left part of FIG. 3. Movement of the media sheet 100 may be accomplished by rollers 306A, 306B, 306C, and 306D, collectively referred to as the rollers 306, or by another type of advancement mechanism.

As each linear portion of the media sheet 100 is underneath, or incident to, the optical scanning mechanism 302, the optical scanning mechanism 302 emits light against the linear portion, and detects the light reflected by that linear portion, as indicated by the reference number 304. Therefore, each of the linear portions of the media sheet 100 is ultimately scanned in this way as the media sheet 100 moves past the optical scanning mechanism 302. The media sheet 100 may be advanced by a variable amount after each linear portion has been optically scanned to achieve irregular spacings between the linear portions. Alternatively, the media sheet 100 may be advanced at a constant velocity, and the optical scanning mechanism 302 turned on and off at variable timings, such as by waiting variable lengths of time in between scanning successive linear portions, to achieve the irregular spacings. The scanning accomplished in the side profile 300 of FIG. 3 is common to sheet-fed scanners.

In the side profile 400 of FIG. 4, the media sheet 100 is stationary, and the optical scanning mechanism 302 is mobile in the direction of movement indicated by the arrow 404. The media sheet 100 specifically rests on a housing 402 that has a glass or otherwise transparent top surface, and the optical scanning mechanism 302 scans the media sheet 100 from below. The top of the media sheet 100 corresponds to the left part of FIG. 4, whereas the bottom of the media sheet 100 corresponds to the right part of FIG. 4. Movement of the optical scanning mechanism 302 may be accomplished by one or more motors, or another type of advancement mechanism.

As each linear portion of the media sheet 100 is over, or incident to, the optical scanning mechanism 302, the optical scanning mechanism 302 emits light against the linear portion, and detects the light reflected by that linear portion, as indicated by the reference number 304. Therefore, each of the linear portions of the media sheet 100 is ultimately scanned in this way as the optical scanning mechanism 302 moves past the media sheet 100. The optical scanning mechanism 302 may be advanced by a variable amount after each linear portion has been optically scanned to achieve irregular spacings between the linear portions. Alternatively, the optical scanning mechanism 302 may be moved or advanced at constant velocity, and the optical scanning mechanism turned on and off at variable timings, such as by waiting variable lengths of time in between scanning successive linear portions, to achieve the irregular spacings. The scanning accomplished in the side profile 400 of FIG. 4 is common to flatbed scanners.

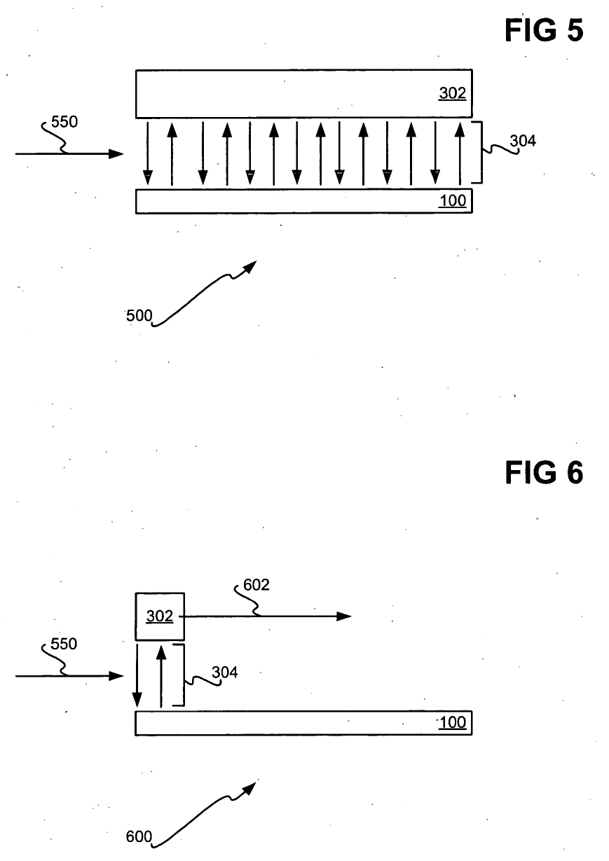

FIGS. 5 and 6 show front profiles 500 and 600, respectively, of how optical scanning can be accomplished by scanning all the positions of a linear portion of the media sheet 100 at the same time or in succession, according to different embodiments of the invention. The front profiles 500 and 600 are the views achieved by looking at the side profiles 300 and 400 as denoted by the arrow 350 in FIGS. 3 and 4. Similarly, the side profiles 300 and 400 are the views achieved by looking at the front profiles 500 and 600 as denoted by the arrow 550 in FIGS. 5 and 6. Either the profile 500 of FIG. 5 or the profile 600 of FIG. 6 can be achieved with either the profile 300 of FIG. 3 or the profile 400 of FIG. 4.

In the front profile 500 of FIG. 5, the optical scanning mechanism 302 is stationary from left to right of the media sheet 100, even though the optical scanning mechanism 302 may be mobile from top to bottom of the media sheet 100, as in the side profile 400 of FIG. 4. The left of the media sheet 100 corresponds to the left part of FIG. 5, and the right of the media sheet 100 corresponds to the right part of FIG. 5. In FIG. 5, one linear portion is incident to the optical scanning mechanism 302. Therefore, the optical scanning mechanism 302 emits light onto all the positions of this linear portion, and detects the light reflected by all the positions of this linear portion, as indicated by the reference number 304. Thus, the linear portion that is incident to the optical scanning mechanism 302 in FIG. 5 is optically scanned at one time, in that all the positions of this linear portion are optically scanned at the same time. The scanning accomplished in the front profile 500 of FIG. 5 is common to dedicated scanners that are either flatbed or sheet-fed scanners.

In the front profile 600 of FIG. 6, the optical scanning mechanism 302 is mobile from left to right of the media sheet 100, even though the optical scanning mechanism 302 may be stationary from top to bottom of the media sheet, as in the side profile 300 of FIG. 3. The left of the media sheet 100 corresponds to the left part of FIG. 6, and the right of the media sheet corresponds to the right part of FIG. 6. In FIG. 6, one position of one linear portion is incident to the optical scanning mechanism 302 at any given time. Therefore, the optical scanning mechanism 302 emits light onto this position, and detects the light reflected by this position, as indicated by the reference number 304. The mechanism 302 is then moved over each of the positions of the linear portion in question, as indicated by the arrow 602, so that all of the positions of this linear portion of the media sheet 100 can be optically scanned. Thus, the linear portion that is incident to the optical scanning mechanism 302 in FIG. 6 is optically scanned a position at a time, in that the positions of this linear portion are optically scanned in succession. The scanning accomplished in the front profile 600 of FIG. 6 is common to inkjet-printing devices in which inkjet-printing mechanisms can be temporarily replaced by optical scanning mechanisms to temporarily convert the devices into scanning devices.

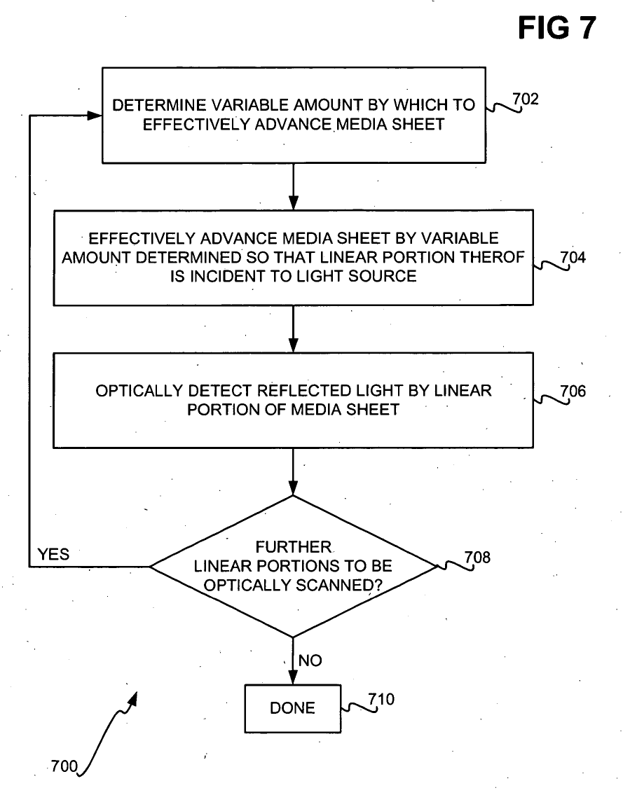

FIG. 7 shows a method 700 for optically scanning a media sheet by scanning irregularly spaced linear portions of the media sheet, according to an embodiment of the invention. A variable amount by which to effectively advance the media sheet is determined (702). This variable amount may be determined by adding a random value that has a lower negative limit and an upper positive limit to a target amount or value. The variable amount may also be determined by looking up the variable amount within a predefined table of advancement amounts, or by performing a mathematical function or algorithm to yield the variable amount. The average of all the variable amounts determined may be at least substantially equal to a predetermined target value.

The media sheet is thus effectively advanced by the variable amount determined so that a given irregularly spaced linear portion is incident to a light source of an optical scanning mechanism (704). That the media sheet is effectively advanced means that the media sheet is effectively advanced relative to an optical scanning mechanism, either by physically or actually advancing the media sheet, as in FIG. 3, or by physically or actually advancing the mechanism, as in FIG. 4. That is, that the media sheet is effectively advanced encompasses either the media sheet being actually advanced relative to the optical scanning mechanism, or the optical scanning mechanism being actually advanced relative to the media sheet. In either situation, the media sheet is thus “effectively” advanced relative to the optical scanning mechanism.

The light reflected by the linear portion incident to the light source of the optical scanning mechanism is then optically detected (706), such as by one or more light detectors of the optical scanning mechanism. The light reflected by all the positions of the linear portion may be detected at the same time, as in FIG. 5. Alternatively, the light reflected by each position of the linear portion may be detected in succession, as in FIG. 6. If there are further linear portions to be optically scanned (708), then the method 700 repeats beginning at 702. Otherwise, the method 700 is finished (710).

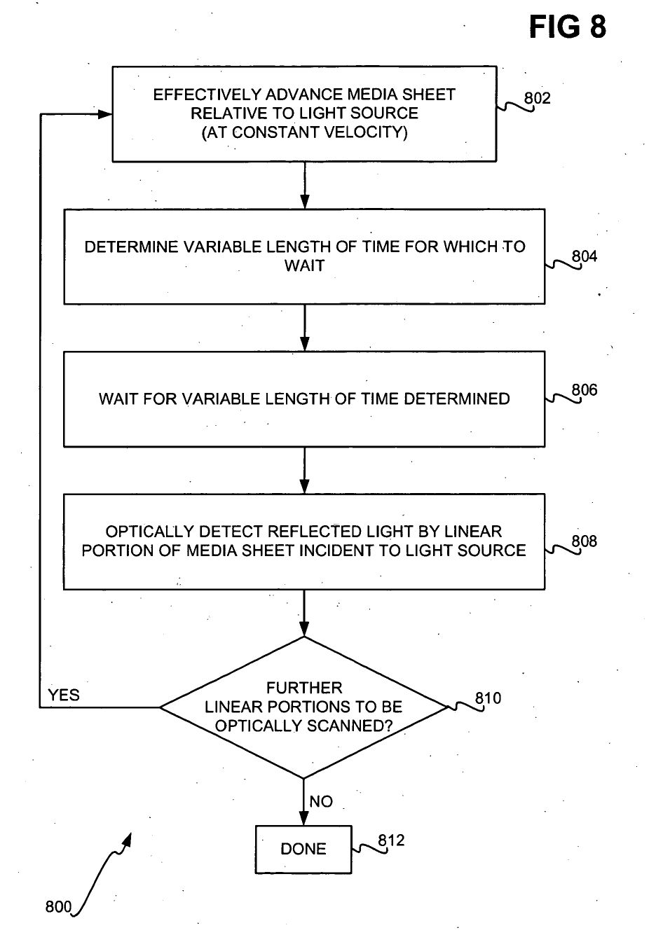

FIG. 8 shows a method 800 for optically scanning a media sheet by scanning irregularly spaced linear portions of the media sheet, according to another embodiment of the invention. The media sheet is effectively advanced relative to a light source of an optical scanning mechanism (802), where such advancement may be accomplished at a constant velocity. As before, the media sheet may be physically or actually advanced, as in FIG. 3, or the optical scanning mechanism may be physically or actually advanced, as in FIG. 4. In either situation, the media sheet is thus “effectively” advanced relative to the optical scanning mechanism.

A variable length of time for which to wait is determined (804). This variable length of time may be determined by adding a random value that has a lower negative limit and an upper positive limit to a target length of time or value. The variable length of time may also be determined by looking up the variable length of time within a predefined table, or by performing a mathematical function or algorithm to yield the variable length of time. The average of all the variable lengths of time determined may be at least substantially equal to a predetermined target length of time.

This variable length of time is then waited for by the method 800 (806), so that a given irregularly spaced linear portion is incident to a light source of an optical scanning mechanism. Waiting for a variable length of time achieves irregularly spaced linear portions, since the timing at which the linear portions of the media sheet are optically scanned is variable. That is, from a beginning point in time t₀, a first timing t₁ after which a first linear portion of the media sheet is incident to the optical scanning mechanism may result from waiting for a length of time l₁. A second timing t₂ after which a second linear portion is incident to the mechanism may then result from waiting for a length of time l₂. Because the length of time l₁ is not necessarily equal to the length of time 12, the timing t₁ is irregular as compared to the timing t₂, such that the first linear portion is irregularly spaced as compared to the second linear portion.

The lengths of time that are variably determined and waited for may therefore be considered as the basis by which variable timings are determined at which different linear portions of the media sheet are incident to the optical scanning mechanism. Thus, determining the variable length of time to be waited for may be considered as the basis by which variable timings are determined. Such variable timings can therefore be said to be determined by adding random values to target timing values, by looking up the variable timings within a predefined table, or by performing a mathematical function or algorithm to yield the variable timings. The average of all the variable timings determined may be at least substantially equal to a target variable timing value.

The light reflected by the linear portion incident to the light source of the optical scanning mechanism is then optically detected (808). For example, the light source and/or optical detectors of the optical scanning mechanism may be turned on to optically detect the light reflected by the linear portion of this light source. In one embodiment, the light source stays on all the time, and the light detectors are read—or “turned on”—when a linear portion in question is incident to the light source, after waiting for the variable length of time. In another embodiment, the light source, too, is turned on and off when a linear portion in question is incident to the light source, after waiting for the variable length of time. If further linear portions are to be optically scanned (810), then the method 800 repeats at 802. Otherwise, the method 800 is finished (812).

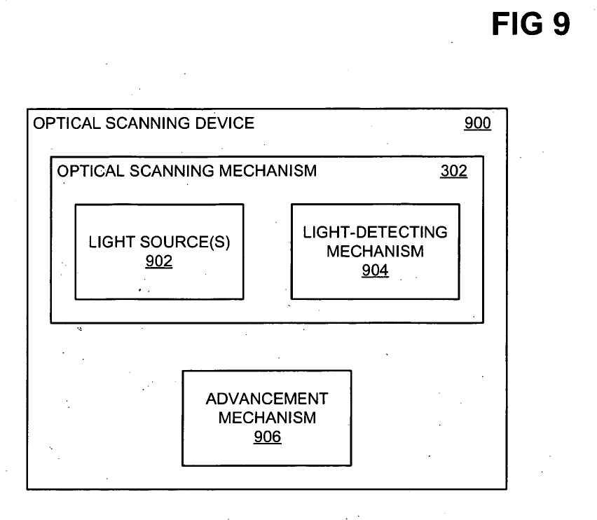

FIG. 9 shows an optical scanning device 900, according to an embodiment of the invention. The optical scanning device 900 includes the optical scanning mechanism 302 that has been described, and an advancement mechanism 906. As can be appreciated by those of ordinary skill within the art, the device 900 can include other components, in addition to and/or in lieu of those depicted in FIG. 9.

The optical scanning mechanism 302 is made up of one or more light sources 902, and a light-detecting mechanism 904. The light sources 902 may include incandescent light sources, light-emitting diodes (LED's), as well as other types of light sources. The light sources 902 illuminate the linear portions of a media sheet as the linear portions become incident to the light sources 902. The light-detecting mechanism 904 may include one or more light detectors, such as photodiodes, phototransistors, and other types of light detectors. The light-detecting mechanism 904 detects light from the light sources 902 as reflected by one or more positions of each linear portion of the media sheet, as the positions of the linear portion of the media sheet become incident to the light sources 902.

The advancement mechanism 906 is to effectively advance the media sheet relative to the optical scanning mechanism 302, such as either the light sources 902 and/or the light-detecting mechanism 904 of the optical scanning mechanism 302. The advancement mechanism 906 may include motors, rollers, and other components. The advancement mechanism 906 in one embodiment actually or physically moves the media sheet past the optical scanning mechanism 302. In another embodiment, the advancement mechanism actually or physically moves the optical scanning mechanism 302 past the media sheet. In either embodiment, it thus can be considered that the media sheet is “effectively” advanced relative to the optical scanning mechanism 302.

Either or both of the light sources 902 and the light-detecting mechanism 904 functionally cooperate with the advancement mechanism 906 so that the linear portions of the media sheet are irregularly spaced relative to one another, as has been described. For example, in one embodiment, after one linear portion of the media sheet has been optically scanned, either the optical scanning mechanism 302 or the media sheet is advanced by a variable amount to achieve irregularly spaced linear portions. In another embodiment, the optical scanning mechanism 302 or the media sheet is advanced at a constant velocity, and irregular timings, which can be achieved by waiting for a variable length of time after each linear portion, provide for irregularly spaced linear portions.

In one embodiment, the user may be able to select the mode of operation in which the optical scanning device. In a first mode of operation, the linear portions of the media sheet may be irregularly spaced, as has been described. In a second mode of operation, the linear portions of the media sheet may instead be regularly spaced. Thus, the user in this instance may select the first mode when scanning media sheets on which there are images that are susceptible to Moiré patterns or other visual artifacts that can be reduced or eliminated by having irregularly spaced linear portions. The user may instead select the second mode when scanning media sheets on which there are not images that are susceptive to Moiré patterns or other visual artifacts.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. Therefore, it is manifestly intended that this invention be limited only by the claims and equivalents thereof.

I claim:

1. A method for optically scanning a media sheet comprising:
effectively advancing the media sheet relative to a light source, such that the media sheet is logically divided into a plurality of linear portions, each linear portion having a plurality of positions, and the linear portions irregularly spaced relative to one another; and,
as the light source becomes incident to each position of each linear portion of the media sheet, optically detecting light reflected by the position to optically scan the position.

2. The method of claim 1, wherein the linear portions are irregularly spaced relative to one another in that distances between immediately adjacent linear portions of the media sheet are not necessarily equal to one another.

3. The method of claim 1, wherein effectively advancing the media sheet relative to the light source comprises effectively advancing the media sheet by a variable amount between immediately adjacent linear portions thereof, so that distances between immediately adjacent linear portions of the media sheet are irregular.

4. The method of claim 3, further comprising determining the variable amount each time the media sheet is effectively advanced by adding a random value to a target amount, the random value having a lower negative limit and an upper positive limit.

5. The method of claim 3, further comprising determining the variable amount each time the media sheet is effectively advanced by looking up the variable amount within a predefined table of advancement amounts.

6. The method of claim 3, further comprising determining the variable amount each time the media sheet is effectively advanced by performing a mathematical function to yield the variable amount.

7. The method of claim 1, wherein effectively advancing the media sheet relative to the light source comprises effectively advancing the media sheet relative to the light source at a constant speed, where a timing at which the positions of each linear portion of the media sheet are optically scanned as the media sheet is effectively advanced at the constant speed is variable, so that distances between immediately adjacent linear portions of the media sheet are irregular.

8. The method of claim 7, further comprising determining the timing at which the positions of each linear portion of the media sheet are optically scanned by adding a random value to a target timing value, the random value having a lower value having a lower negative limit and an upper positive limit.

9. The method of claim 7, further comprising determining the timing at which the positions of each linear portion of the media sheet are optically scanned by looking up the timing within a predefined table of variable timings.

10. The method of claim 7, further comprising determining the timing at which the positions of each linear portion of the media sheet are optically scanned by performing a mathematical function to yield a variable timing.

11. A method for optically scanning a media sheet comprising:
effectively advancing a media sheet by a variable amount so that a linear portion of the media sheet is incident to a light source;
optically detecting reflected light by the linear portion of the media sheet; and,
repeating effectively advancing the media sheet by the variable amount and optically detecting the reflected light until the media sheet has been completely optically scanned.

12. The method of claim 11, further comprising determining the variable amount each time the media sheet is to be effectively advanced, by one of:
adding a random value to a target amount, the random value having a lower negative limit and an upper positive limit;
looking up the variable amount within a predefined table of advancement amounts; and,
performing a mathematical function to yield the variable amount.

13. The method of claim 11, wherein an average of the variable amount by which the media sheet is effectively advanced over all times the media sheet has been effectively advanced in optically scanning the media sheet is at least substantially equal to a predetermined target value.

14. A method for optically scanning a media sheet comprising:
effectively advancing a media sheet relative to a light source;
waiting for a variable length of time;
optically detecting reflected light by a linear portion of the media sheet currently incident to the light source; and,
repeating waiting for the variable length of time and optically detecting the reflected light until the media sheet has been completely optically scanned.

15. The method of claim 14, further comprising determining the variable length of time each time the variable length of time is to be waited for, by one of:
adding a random value to a target value, the random value having a lower value having a lower negative limit and an upper positive limit;
looking up the variable length of time within a predefined table of variable lengths of time; and,
performing a mathematical function to yield the variable length of time.

16. The method of claim 14, wherein an average of the variable length of time waited over all times the variable length of time has been waited in optically scanning the media sheet is at least substantially equal to a predetermined target value.

17. An optical scanning device comprising:
a light source to illuminate each of a plurality of linear portions of a media sheet as each linear portion becomes incident to the light source;
a light-detecting mechanism to detect light from the light source as reflected by at least one of a plurality of positions of each linear portion of the media sheet as the positions of each linear portion of the media sheet become incident to the light source; and,
an advancement mechanism to effectively advance the media sheet relative to the light source and the light-detecting mechanism,
wherein the light-detecting mechanism and the advancement mechanism functionally cooperate so that the linear portions of the media sheet are irregularly spaced relative to one another.

18. The optical scanning device of claim 17, wherein the linear portions are irregularly spaced relative to one another in that distances between immediately adjacent linear portions of the media sheet are not necessarily equal to one another.

19. The optical scanning device of claim 17, wherein irregular spacing of the linear portions of the media sheet is achieved by the advancement mechanism effectively advancing the media sheet by variable amounts and the light-detecting mechanism detecting the light as reflected by one of the linear portions of the media sheet after each time the media sheet has been effectively advanced by one of the variable amounts.

20. The optical scanning device of claim 17, wherein irregular spacing of the linear portions of the media sheet is achieved by the advancement mechanism effectively advancing the media sheet at a constant velocity and the light-detecting mechanism repeatingly detecting the light as reflected by one of the linear portions of the media sheet after waiting for a variable length of time.

21. An optical scanning device comprising:
means for illuminating each of a plurality of irregularly spaced linear portions of a media sheet;
means for detecting light from the light source as reflected by each irregularly spaced linear portion of the media sheet; and,
means for effectively advancing the media sheet.

22. The optical scanning device of claim 21, wherein the irregularly spaced linear portions are irregularly spaced relative to one another such that distances between immediately adjacent linear portions of the media sheet are not necessarily equal to one another.

23. An optical scanning device comprising:
a light source to illuminate each of a plurality of linear portions of a media sheet as each linear portion becomes incident to the light source;
a light-detecting mechanism to detect light from the light source as reflected by at least one of a plurality of positions of each linear portion of the media sheet as the positions of each linear portion of the media sheet become incident to the light source; and,
an advancement mechanism to effectively advance the media sheet relative to the light source and the light-detecting mechanism,
wherein the light-detecting mechanism and the advancement mechanism have a first mode of operation in which the linear portions of the media sheet are irregularly spaced relative to one another and a second mode of operation in which the linear portions of the media sheet are regularly spaced relative to one another.

24. The optical scanning device of claim 23, wherein the linear portions are irregularly spaced relative to one another in the first mode of operation such that distances between immediately adjacent linear portions of the media sheet are not necessarily equal to one another.

25. The optical scanning device of claim 23, wherein the optical scanning device is to recommend to a user thereof to select the first mode of operation when the media sheet to be scanned contains half-toned graphical images, and to otherwise select the second mode of operation.
